(19) United States
(12) Patent Application Publication
(10) Pub. No.: US 2015/0007775 A1
(43) Pub. Date: Jan. 8, 2015

(54) ANIMAL SHELTER STRUCTURE

(71) Applicant: Herd Homes Limited, Whangarei (NZ)

(72) Inventor: Thomas George Pow, Whangarei (NZ)

(21) Appl. No.: 14/496,906

(22) Filed: Sep. 25, 2014

Related U.S. Application Data
(63) Continuation of application No. 12/602,489, filed on Feb. 2, 2010.

(30) Foreign Application Priority Data
May 29, 2007 (NZ) 555517

(51) Int. Cl. A01K 1/00; F24F 13/10; A01J 7/00; F24F 7/00; A01K 1/01; A01K 1/015

(52) U.S. Cl. CPC A01K 1/0058; A01K 1/0076; A01K 1/01; A01K 1/0151; A01J 7/00; F24F 7/00; F24F 13/10
USPC 119/14.02; 119/448; 119/450; 454/322

(57) ABSTRACT

An at least partially open sided outdoor animal shelter structure to condition animals, when positioned within the structure, to a desired physiological state by controlling the environment in the structure, the structure including a floor to support animals, side supports, a water impervious canopy supported by the side supports, the canopy being supported above at least part of the floor, the canopy allowing at least some ambient light to pass therethrough and into the structure, and wherein there are ways in which to control the temperature and/or airflow under the canopy in a passive manner such as by a movable shade cloth, that in one condition is located intermediate of the canopy and the animals to offer shade to the animals when in the structure and in at least one other condition is retracted from being positioned to offer shade to such animals.

### FIELD OF INVENTION

The present invention relates to animal shelters structures and related methods.

### BACKGROUND

Pugging and compaction damage of grazing pasture can occur by grazing animals, or farm vehicles and machinery. This can occur when the soil is soft such as when it is wet and the weight of the animals or vehicles cannot be adequately supported by the soil's surface. Pugging can result in poor drainage, keeping the soil soft and wet. Pugging and compaction damage can also result in reduced pasture utilisation as well as a reduction in future pasture yield, depending upon the soil type. Pugging also allows weeds and poor species of grasses to become established. Moreover, pugging and compaction damage requires more tractor passes for seed bed preparation and sowing and greater fertiliser and topsoil requirements. However, it may not always be possible to add the necessary increased fertiliser requirement due to some region's/country's regulations regarding runoff of nitrogen into the waterways.

In order to address the problem of runoff, and/or pugging and/or compaction damage of grazing pastures, stand-off pads are often used. Stand-off pads are generally purpose-built, loafing or standing spaces where stock can be held for long periods when it is not suitable to have them on pasture. This may occur for example during a wet season, inclement weather, or when it is otherwise undesirable to have cattle or other livestock on pasture.

It may also be advantageous to have animals on the stand off pads in fine weather. It keeps the animal waste in one locations and reduces animal waste being dropped on the farm land that may eventually make its way into a water system.

WO2004/022883 describes a stand off pad that includes a shelter canopy for the animals. This may protect the animals during inclement weather. It may also keep the sun of the animals in hot weather. The shelter may not cater for the extremes in temperature and wind flow in the region, to ensure that the animals are kept at or as close as possible to a desired temperature.

Furthermore, it may also be desirable to subject any animal waste matter that is dropped by the animals at the shelter to be subjected to certain environmental conditions. Primarily, an evaporate condition may be desired, where urine is evaporated away from solid waste so that the solid waste can be used at a later stage without there also being present in great quantities, the liquid waste. The environmental conditions desired for animal stand-off and for liquid waste evaporation may not always be compatible.

The invention of WO2004/022883 describes a roof that can help keep precipitation out and increase the temperature inside the structure for the purposes of aiding drying of waste matter on the floor and in the basement. However during certain times of the day it may be undesirable for animals to be located under the roof. In particular certain animals are quite sensitive to environmental conditions. In particular body temperature and heat exchange factors can have an influence on for example milk productivity of animals. Prolonged stand-off periods during hot weather can adversely affect an animal's productivity, particularly under a covered stand-off facility where air circulation may reduce heat exchange. Accordingly the invention described in WO2004/022883 has some further limitations.

It is an object of the present invention to provide an animal shelter structure that at least has improved performance and environmental control over that prior art and/or to at least provide the public with a useful choice.

### BRIEF DESCRIPTION OF THE INVENTION

Accordingly the present invention consists An at least partially open sided outdoor animal shelter structure to condition animals, when positioned within the said structure, to a desired physiological state by controlling the environment in the structure, said structure including:
a. a floor to support animals, preferably said floor includes apertures therethrough allowing animal waste matter to pass through the floor,
b. preferably a basement below said floor for collecting said waste matter,
c. preferably floor supports to support said floor above said basement,
d. side supports,
e. a water impervious canopy supported by said side supports, said canopy being supported above at least part of said floor, said canopy allowing at least some ambient light to pass therethrough and into said structure,
f. an environment modification means selected from at least one of a movable shade cloth, that in one position is located intermediate of the canopy and the animals when located in the structure and an airflow controller(s) to control airflow impinging the structure to control the direction of flow of air below said canopy.

Preferably said canopy is curved.

Preferably said airflow controller(s) includes a plurality of horizontally extending and parallel louvre boards that (a) are proximate said canopy to define air inlets between said louvre boards and (b) extends outwardly and downwardly along one or more sides of the structure, to direct airflow incoming to the area below the canopy in a direction parallel to the underside of the canopy.

Preferably said canopy includes at least one closable vent (preferably at the apex of the canopy).

Preferably the shade cloth can be positioned above at least part of the floor and below said canopy to, in at least one configuration shade at least part of the floor from ambient light (e.g. sunlight) entering the structure.

Preferably the shade cloth includes two independently moveable parts with a gap able to be defined between adjacent edges of each part between the two parts, wherein when a gap is defined, air can escape from below the shade cloth parts to a zone above the shade cloth parts.

Preferably the shade cloth parts can be moved to be positioned to be lower at regions thereof proximate more the perimeter of the structure than inwardly of the perimeter to create a stack effect for rising air below said canopy.

Preferably the shade cloth can be moved between at least two of three configurations, a first configuration wherein the shade cloth extends from opposed sides of the structure upwardly towards the upper central region of the structure, a second configuration wherein the shade cloth extends horizontally, and a third configuration wherein the shade cloth presents at least one and preferably two concave face side down zones.

Preferably the structure is rectangular in plan shape and wherein the shade cloth consists of two parts, each part being substantially rectangular in shape and having its two major sides parallel to two major sides of the structure, wherein one of the major sides of each part is proximate more a respective side of the structure than the opposite major side , wherein the opposite major sides of both parts are proximate each other substantially midway between major sides of the structure, where the opposite major sides can move between (i) an upper position where for each part the opposite major side is higher than the other major side (and preferably at which a gap exists between the parts to allow rising air to escape to the zone between the shade cloth and the canopy and/or out through the canopy vent, and (ii) a lower position where for each part the opposite major side is at substantially the same height as the other major side (and preferably at which no gap exists or any gap between the parts is closed).

In a second aspect the present invention consists in a method of cooling air in an outdoor, at least partially open sided, animal shelter structure of a kind that includes a floor for animals to stand on and above which is supported a light transmissive canopy and wherein a closable vent is provided in the canopy and wherein a movable shade cloth is provided that can extend above at least part of the floor and below the canopy, said method including the steps of:
a. opening the vent, and
b. positioning the shade cloth to shade at least part of the floor from ambient light entering through the canopy (Preferably in a manner to allow air entering the structure through the sides of the structure to either circulate below the shade cloth or, if the shade cloth consists of two parts and is positioned with a gap between parts, to pass into said structure below the shade cloth parts, pass through the gap and into the space between the canopy and the shade cloth ad/or out through any vent in the canopy.

In a further aspect the present invention consists in a method of heating air in an outdoor, at least partially open sided, animal shelter structure of a kind that includes a floor for animals to stand on and above which is supported a light transmissive canopy and wherein a closable vent is provided in the canopy and wherein a movable shade cloth is provided that extends above at least part of the floor and below the canopy, said method including the steps of:
a. closing the vent, and
b. moving the shade cloth to expose more of the floor to ambient light entering through the canopy.

In yet a further aspect the present invention consists in an outdoor animal shelter structure comprising
a. a floor to support animals
b. a canopy, supported above said floor, for animals to stand under, said canopy able to provide at least partial shading from ambient sunlight and cover from precipitation for at least part of said floor, wherein the space between the floor and the canopy is along at least part of one side of the structure open to ambient atmospheric conditions, and
c. air flow control means to control airflow in the space between the canopy and the floor, said airflow controller(s) selected from at least one of:
   i. a least one and preferably a plurality of parallel horizontally extending louvre board located adjacent at least one edge of the canopy yet separated therefrom to define an air inlet to said structure, said louvre boards movable to be oriented to direct part of any appropriately directed ambient airflow incident on the structure, through said inlet(s), and
   ii. a closable opening through said canopy that, in its open condition, can allow airflow out of the space, through said canopy,
   iii. a two part movable shade cloth that can (i) create a stack effect for rising air below said shade cloth parts and (ii) define a ceiling to restrict flow of air from below the shade cloth parts to above them and preferably (iii) assume a curved condition so as to present a concave ceiling that will encourage air to circulate below said shade cloth.

Preferably the structure is four sided in plan shape and at least two of the sides are at least partially open to ambient atmospheric conditions and wherein a said louvre board(s) is provided at or near each of said open sides.

In still a further aspect the present invention consists in a structure as herein described wherein the canopy is varied in height above said floor wherein the lower most parts of the canopy are disposed proximate said two opposed sides of said structure and at least one apex of the canopy is positioned intermediate thereof.

Preferably the canopy extends upwardly from each of said two opposed sides toward the apex.

Preferably the louvre board projects away from said space in a downward direction in order to encourage said ambient airflow to enter said space in an upward direction.

Preferably said canopy is uni-directionally curved and defines an elongate apex extending intermediate of two opposed sides of said structure.

Preferably said closable opening is positioned along at least part of the apex of said canopy.

Preferably the closable opening is closable by a closure that is pivotally supported to move relative said canopy between a position closing said opening and a position to allow airflow through said opening.

Preferably the floor is supported above a basement and wherein the floor includes a plurality of apertures to allow waste matter to drop through the floor and into the basement.

Preferably the floor is elevated above at least some ground adjacent to where the structure is positioned to define an opening via which part of any appropriately directed ambient airflow incident on the structure to pass into the basement.

Preferably at least one side of the structure the basement includes an opening directly exposed to ambient atmospheric conditions to allow part of any appropriately directed ambient airflow to enter the basement.

Preferably an airflow control means is provided to alter airflow through said opening to said basement.

Preferably said airflow control means is a movable baffle.

Preferably said baffle can be positioned to scoop airflow towards said opening.

Preferably said baffle can be positioned to constrict airflow through said opening.

In still a further aspect the present invention consists in a method of a conditioning dairy animal prior to it being milked, to encourage its condition towards a homeo-static physiological state to improve milk yield (whether milk quality or quantity or both), the method including moving or allowing movement of the dairy animal into a shelter structure as herein described that is configured to create an environment for the dairy animal to remain in for a duration prior to milking, that will tend the condition of the dairy animal towards the desired homeo-static physiological state.

Preferably the method includes keeping the dairy animal in the shelter structure for at least 10 minutes before advancing or allowing movement of the dairy animal from the shelter structure to a location for their milking.

Preferably the shelter structure includes environment sensors that allow at least one environment measurement to be taken and used for recordal and/or processing and/or feedback control for structure configuration.

In yet a further aspect the present invention consists in a method of conditioning cows prior to their being milked to encourage them to or towards an optimal homeostatic physiological condition for milk productivity and/or milk quality, the method including moving or allowing movement of cows from a location where they are subjected to environmental conditions that can have an adverse effect on the physiological condition of the cows, into a shelter structure as herein descried the structure configured to create an environment for the cows to remain in for a duration prior to milking that will tend the cows towards the optimal homeostatic physiological condition.

In yet a further aspect the present invention consists in an outdoor animal shelter structure comprising
a. a floor to support animals,
b. a canopy, supported above said floor, for animals to stand under, said canopy able to provide at least partial shading from ambient sunlight and cover from precipitation to at least part of said floor,
c. two drooping shade cloth parts each positioned intermediate of said canopy and said floor and under which said animals can stand to provide at least a partial barrier to the passing of sunlight to below said shade cloth and to facilitate the flow of air below said shade cloths in an inward and upward direction in the structure.

In even a further aspect the present invention consists in an at least partially open sided outdoor animal shelter structure to condition animals, when positioned within the said structure, to a desired physiological state by controlling the environment in the structure, said structure including:
a. a floor to support animals
b. side supports,
c. a water impervious canopy supported by said side supports, said canopy being supported above at least part of said floor, said canopy allowing at least some ambient light to pass therethrough and into said structure,
d. a movable shade cloth, that in one condition is located intermediate of the canopy and the animals to offer shade to the animals when in said structure and in at least one other condition is retracted from being positioned to offer shade to such animals.

Preferably the shade cloth can be moved to a condition to encourage updraft of air in said structure.

Preferably said shade cloth can be moved to a condition where at least one part of it is/are elevated more than other parts and wherein at the elevated most part(s) includes an aperture to allow rising air to pass therethrough.

Preferably said canopy includes a closeable opening to allow rising air to pass therethtough.

In still a further aspect the present invention consists in animal shelter as herein before described and as herein before described and with reference to the accompanying drawings.

In still a further aspect the present invention consists in animal shelter as described and with reference to the accompanying drawings.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

### BRIEF DESCRIPTION OF THE DRAWINGS

Further aspects of the present invention will become apparent from the following description which is given by way of example only and with reference to the accompanying drawings, in which:

FIG. 1 is an end view of an animal shelter structure that includes a canopy above a ventilated covered space,

FIG. 2 is an end view of an animal shelter structure showing further aspects that include adjustment means for environmental control features,

FIG. 3 is an end view of an animal shelter structure showing a canopy venting feature in an open condition,

FIG. 4 is an end view of an animal shelter structure showing a sensor that enables adjustment of environmental control features,

FIG. 5 is a perspective view of an animal shelter structure showing one configuration of the shade cloths,

FIG. 6 is a perspective view of an animal shelter structure showing another configuration of the shade cloths,

FIG. 7 is an end view of FIG. 5 showing the internal air circulation of an animal shelter structure.

FIG. 8 is an end view of FIG. 6 showing the internal air circulation of an animal shelter structure, and

FIG. 9 is a perspective view of an animal shelter structure showing the features which support the shade cloths,

FIG. 10 is an end view of an animal shelter structure a further configuration of the shade cloths.

### DETAILED DESCRIPTION OF THE INVENTION

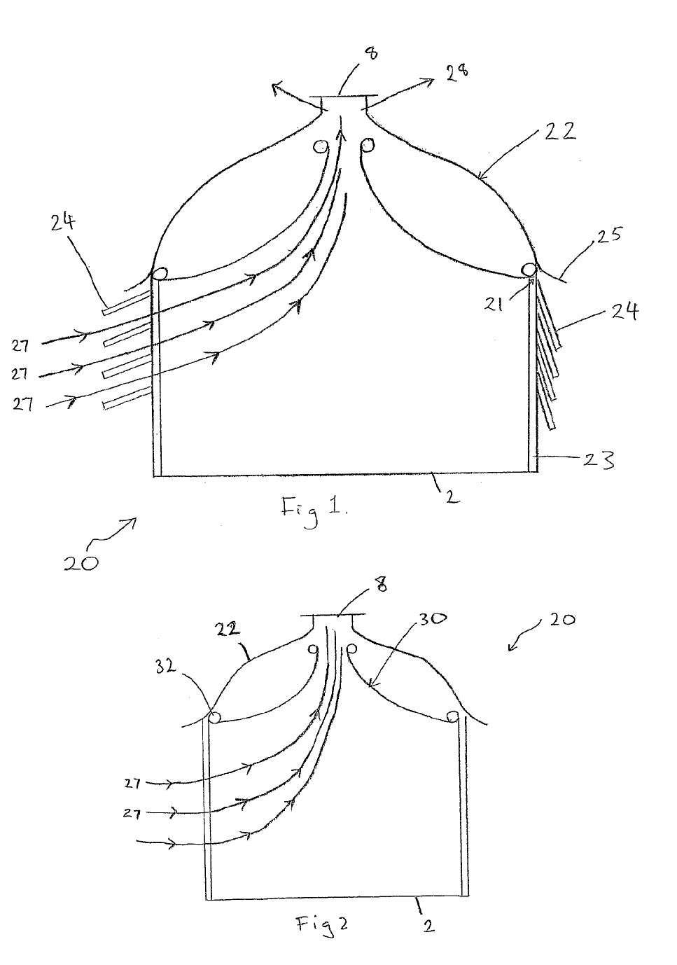

In FIG. 1, there is shown an animal shelter structure 20. The structure 20 is preferably a four sided structure that includes a canopy 22 covering a covered space. The structure is preferably an open sided structure having at least one and preferably all of its four sides at least partially open. The structure 20 preferably has a curved and closed or closeable canopy 22, supported by and above side supports 23 such as posts or props.

The structure is provided with louvre boards 24 that are provided to assist in modifying the environment within the covered space. The louvre boards are preferably provided along at least two opposed sides of the structure. There is at least one louvre board at each side although a plurality of louvre boards positioned in an overlapping manner may be provided. Louvre boards 24 may extend along at least two opposing or all sides of the structure 20. Where the structure 20 is rectangular in plan shape the louvre boards are preferably located at the major opposing sides. The louvre boards 24 are preferably situated below the lower edges 25 of the canopy 22.

The louvre boards are preferably downwardly and outwardly extending from the lower edge 25 of the canopy 22. They are preferably angled at approximately 45 degrees with respect to the side supports 23 and extend generally the length of the sides of the structure 20 at where they are positioned. The angle that the louver boards 24 make with respect to the side supports 23 may be adjustable. One or more louvre boards end on end may be used. One or more at least partially overlapping louvre boards may also be used.

The louvre boards 24 may measure approximately 750 mm from the side supports 23 to their tips. Furthermore, the louvre boards 24 may be joined to the side supports 23 approximately 300 mm below the tops 21 of the side supports 23.

When in an open arrangement the louvre boards 24 allow for airflow 27 to enter into the covered space of the structure 20.

Airflow 27 passing into the covered space is initially deflected upwards by the louvre boards 24 into the upper zones of the covered space.

In FIG. 2, there is shown the same shelter structure 20. The structure 20 may incorporate one or more adjustable shade cloths 30. The shade cloths 30 may absorb light which enters the structure through the transparent or translucent roof 22. The shade cloths 30 may be of a material that serves to provide shade from light passing through the roof. For example during sunny weather and when animals are standing on the floor 2, shading may be desirable in order to keep the temperature of the shaded area at desired levels. The shade cloths 30 may also serve to act as a barrier for heat in the upper regions of the enclosed space above the cloths to remain separated from the area below the cloths. The shade cloths may be mounted on spools 32 to allow them to be extended and retracted.

In one configuration the shade cloths 30, when extended, allow air to travel upwardly through the structure and exit through the closable vent 8.

The configuration which the shade cloths 30 can assume internally of the structure 20 creates a “stack” effect. Air may be drawn into the covered space through the open sides of same as indicated by arrows 27. This may be assisted by louvers 24. Upon entry into the structure 20, the air is directed upwards, and due to the configuration of the shade cloth 30, the air can exit through the closable vent 8.

The end result is that the combination of louvre boards 24 and shade cloth 30 can enhance environmental conditions within the covered space. Such enhancement may, for example be to increase air circulation within the covered space to improve drying and/or evaporation of waste matter. The increased air circulation can also improve air displacement rates through the covered space to displace evaporated waste to the surrounding environment. Enhanced environmental conditions resultant from the louvre boards may also be established to aid in a cooling of animals that may be inside covered space. This may be desirable on hot days and where the temperature inside the enclosed space would otherwise be much higher than the ambient temperature.

The louvre boards may be adjustable in their position to control the nature of the airflow through the structure 20. They may be adjusted by pivoting at the inner edge of the louvre boards. They may be adjusted to an extent to close the airspace so that their effect on the airflow within the covered space is nil or minimal.

Side supports 23 preferably in the form of posts are provided for supporting the canopy 22. There are preferably no solid side walls to the structure.

The canopy 22 preferably includes a support structure and a translucent plastics cladding material. The cladding material is waterproof and preferably allows light to pass therethrough. The passing through of light can contribute to establishing a desirable environment within the covered space.

The canopy 22 may be provided with a closable vent 8. Controlling the position of the vent 8 can allow for the environment below the canopy to be controlled. With respect to FIG. 1 for example, the vent 8 is open to allow airflow out of the covered space through the open vent 8, indicated by airflow 28. This can have an effect on the evaporation rate of waste matter. A vent of a different configuration is shown in FIG. 3. Here the vent 8A may consist of two panels that are each independently controllable for movement between their closed and an open position. Depending on the wind direction, this may allow a venturi effect to be established aiding in the venting of air from the enclosed space out through the vent 8A. The vent 8A may also be configured to scoop air into the covered space.

The canopy 22 is preferably translucent enough to allow part of the ambient light to enter the covered space. This can allow for a heating of the space below the canopy to occur for the purposes of dehydration and/or heating of animals. One of the purposes of the shade cloth 30 is to reduce heating of animals if ambient light coming through the translucent canopy would otherwise cause over heating of the animals.

The shade cloths 30 are preferably a shade providing material. This may be in the form of a translucent material or a material that has many small apertures therethrough.

The shade providing characteristics of the shade cloths and/or the canopy may provide a full block to sunlight or at least a partial block.

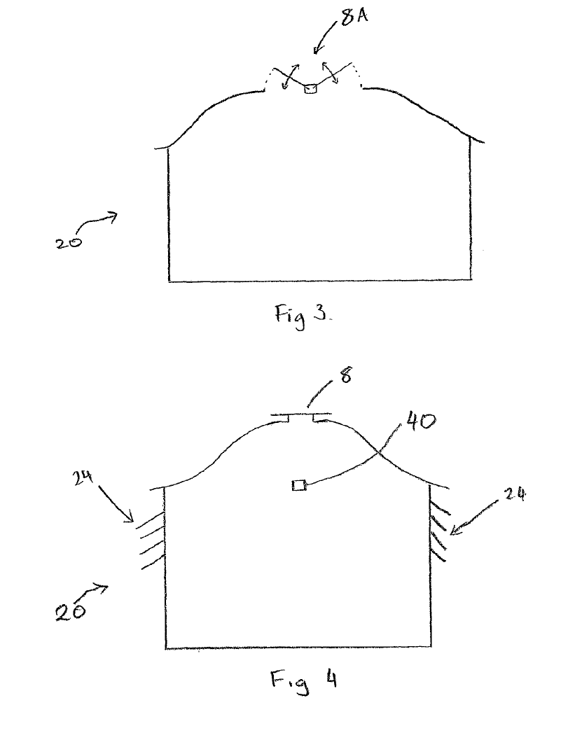

The structure 20, may include at least one environment sensor 40. This is for example shown in FIG. 4. The environment sensor 40 may measure temperature and/or humidity and/or airflow. This sensor may allow for such data to be collected for recordal and analysis purposes. Also the data may be used for further processing including for allowing the environment control features such as the louvre boards 24 and vent 8 to be automatically adjusted to modify the condition of the structure 20. This can allow for automated control of environmental conditions within the shelter to occur. On a hot day the sensor 40 may control components of the shelter to effect a cooling of at least some of the covered space when that is desired. On a cold day the sensor 40 may effect a reconfiguration of the shelter to result in a heating of the at least some of the covered space when that is desired. On a day with little wind the sensor 40 may effect a change in the configuration of the structure to increase air circulation and/or ventilation. As an example, the sensor 40 could adjust the louvers 24 so air is drawn into the structure 20 in an upwards or downwards direction. Furthermore, dependent on the environmental requirements the sensor 40 could adjust the louvers 24 on either side of the structure 20 to an open or closed position in combination with an open or closed position of the vent 8.

The sensor 40 may be used to detect the presence of animals to allow for the shelter structure to be configured between a configuration benefiting processing of waste material and a configuration benefiting conditioning of the animals. The sensor 40 may operate in conjunction with other controls and/or sensors and/or be pre-programmed to take account of factors such as for example regular milking times during the day where advanced conditioning of the shelter can occur prior to animals arriving.

With reference to FIG. 5 there is shown a shelter structure with one possible configuration of the shade cloths 30. In this configuration the shade cloths 30 extend upwardly from the spools 32. The shade cloths 30 may extend substantially into the upper, central region of the shelter structure as shown in FIG. 5. The more central ends 51 of the shade cloths 30 may be supported, at their corners, to vertical support members 50. Also shown is basement 80.

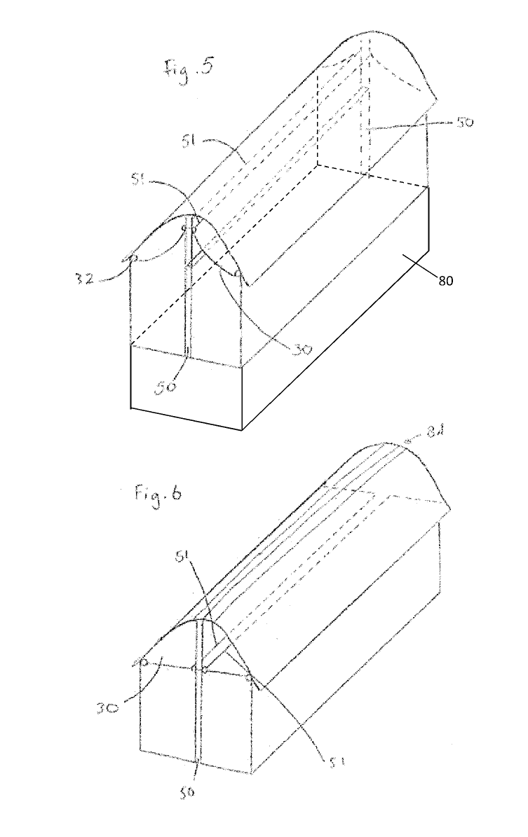

The vertical support members 50 may facilitate the adjustment of the shade cloths 30 to enable different configurations of the shade cloths as shown with reference to FIG. 6. The position of the more central ends 51 of the shade cloths 30 may be adjusted in the vertical direction. The more central ends 51 of the shade cloths 30 can move up and down the vertical support members so the shade cloths 30 may be adjusted to the desired orientation. FIG. 6 shows that shade cloths 30 in a substantially horizontal orientation.

The shade cloths are preferably adjusted automatically between different configurations, but may be adjustable manually also. The automatic adjustment means may raise or lower the more central ends 51 of the shade cloths 30 in the vertical plane defined by the vertical support members 50. Automatic adjustment of the shade cloths may be due to different environmental conditions sensed by the sensor 40. Alternatively, adjustment may occur in accordance with pre-programmed instructions to take account of factors such as for example regular milking times during the day where advanced conditioning of the shelter can occur prior to animals arriving.

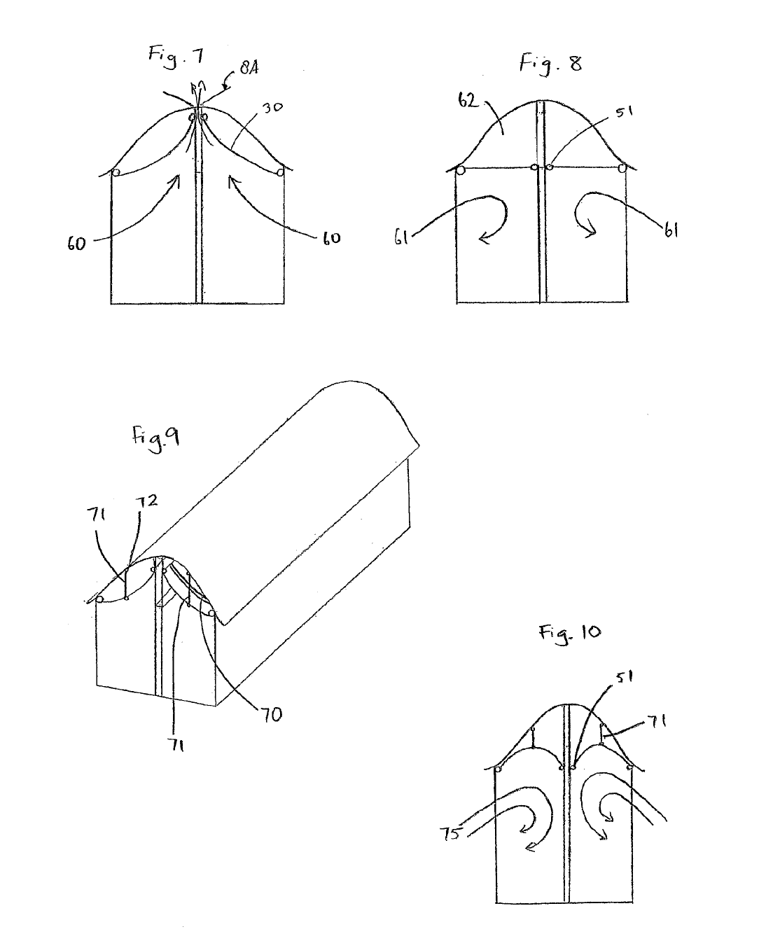

With reference to FIG. 7 there is shown a shelter structure with the shade cloths 30 configured so that they extend substantially into the upper, central region of the shelter structure. This configuration may have an influence on the air circulation inside the shelter structure. Airflow 60 entering the shelter structure through the side walls may be encouraged to flow into the upper, central region of the shelter structure due to the position of the shade cloths 30. In such a configuration a “stack” effect results and the airflow 60 may be directed upwardly and exit the shelter structure through a vent in the roof.

Another configuration of the shade cloths 30 is shown with reference to FIG. 8. In this particular configuration the more central ends 51 of the shade cloths 30 are lowered so that the shade cloths 30 assume a horizontal orientation inside the shelter structure. This configuration causes a “sealing” of the upper region 62 of the shelter structure and results in the inability of airflow to enter that upper region 62. Consequently, airflow 61 which enters the shelter structure may be forced in a downward direction such that it circulates in a manner as shown in FIG. 8.

The shade cloths 30 may incorporate flexible battens 70 which define the shape and curvature of the shade cloths in their different configurations. As shown in FIG. 9, the flexible battens 70 may create a resilience in the shade cloths to restrict them from deforming undesirably when they are in a particular configuration. The flexible battens may be disposed in a particular arrangement. Preferably the flexible battens 70 are spaced uniformly along the shade cloths 30.

Wire suspenders 71 may be incorporated into the shelter structure to control the position of the shade cloths 30. The upper end of the wire suspenders 71 may be affixed to the roof of the shelter structure at point 72. The lower end of the wire suspenders 71 may be affixed to a middle region of the shade cloths 30. There is preferably a means of adjusting the length of the wire suspenders to control the shape and position of the shade cloths 30 in various configurations. Depending on the desired configuration of the shade cloths 30, the length of the wire suspenders 71 may be increased, as shown in FIG. 9 or decreased, as shown in FIG. 10. The wire suspenders may be on a motorised spool which enables their length to be adjusted as desired. There may be a plurality of wire suspenders 71 positioned throughout the shelter to ensure uniformity in the shape of the shade cloths 30 across the entire shelter structure.

With reference to FIG. 10 the shade cloth is in a configuration in which the more central ends 51 of the shade cloths 30 are lowered and the length of the wire suspenders 71 is decreased. In this configuration the wire suspenders “pull” the central region of the shade cloths 30 to create a concave shape in the shade cloths. Airflow 75 which enters the shelter structure may be encouraged to circulate in a manner as shown in FIG. 10 due to the concavity of the shade cloths 30.

Optionally but preferably the shelter structure 20 has a slotted floor and a basement for collection of waste matter produced from the animals.

As can be understood from the foregoing description, the structure 20 can provide efficient and effective environment control for should ambient conditions not suffice or are unable to induce an appropriate environment (such as during cold and hot weather) and for at least one of two purposes, namely to condition animals and aid in dehydration of waste matter. For example, during hot weather, the vent 8 and/or the louvre boards 24 can encourage a cooling and/or shading and/or ventilating effect of at least some of the covered space. Similarly, during cold weather, the heating and/or drying and/or ventilating can be encouraged.

In use, the various environment control features may be utilised to shade and/or cool and/or ventilate the interior of a structure (for example during hot or sunny weather) as follows:

(a) The vent 8 in the canopy 22 may be opened, and the shade cloth 30 (optionally) may be configured so to produce the “stack” effect internally of the structure 20.

(b) With such an arrangement, this (warm) airflow is ultimately deflected or drawn out through the vent 8 in the canopy.

(c) At the same time, the shade cloth 30, if utilised, may serve to provide shade within the structure.

(d) At the same time, the shade material, if utilised, may serve to provide further climate control within the structure.

This configuration can result in a effective shading and/or cooling and/or ventilating effect within the interior of the structure, thus improving the welfare of animals that are within the farm structure, for example during hot or sunny weather. Indeed, we have found during trials that animals are in fact drawn to the structure (with the ventilation means arranged as described) during hot and/or sunny weather.

In a further condition the environment control features may be utilised to heat and/or dry and/or ventilate the interior of the farm structure as follows:

(a) The closable vent 8 in the canopy 22 of the structure 20 may be closed, and (if applicable) the shade cloth 30 retracted or removed.

(b) In such an condition the airflow passing through the louvers 24 will be deflected upwards, before being deflected downwards (by virtue of the nature of the curved roof and/or opposing airflows) in a spiralling motion. Smoke tests have shown that this spiralling effect covers most areas of the interior of the structure above the floor, thus leaving no or little wind shadows within the structure.

(c) At the same time, air may also be drawn into the structure 20 through the open sides. This airflow is enhanced by the presence of the louvre boards 24 and resultant spiralling effect just described.

This configuration is particularly effective during cold weather and results in an efficient heating and/or drying and/or ventilating effect.

The preferred curved canopy 22 means that air entering the covered space through the sides is immediately diffused thereby reducing its velocity and reducing its direct heat transfer effect on animals in the enclosure yet still facilitating air circulation in the structure. The overall effect is that the interior of the structure can be thoroughly heated and/or dried and/or ventilated—thus maximising the welfare of animals within the farm structure, for example during cold or inclement weather. Environmental control within the structure also has and effect on the condition of animal waste collected on the floor and/or in the basement. This has significant benefits in environmental impact of the waste and on animal welfare. We have found during trials that animals are in fact drawn to the structure (with the ventilations means arranged as described) during cold or otherwise inclement weather.

One result may also be that animals have access to a structure that may provide shelter and comfort from all types of weather all year round. This can lead to an improvement in animal welfare that may ultimately results in greater production from the animals.

The shelter allows a prolonged period of “standing off” for animals. It provides a covered area in which a herd can relax, be fed and lie down. The herd can use the shelter day after day with little labour inputs and allows farmers to maximise the farms ability to grow grass: not just when pugging is likely but also when it is advantageous for other reason to look after pasture. In summer the cows can loaf in a shelter in the shade. The result is better-conditioned, unstressed cows, which continue to produce well. Summer pasture recovers better because cows have not “milled”, so production increases.

Having the ability to look after the pasture condition will increase the farm yield significantly.

Animals that feel comfortable due to the environment they are in, can become quiet allowing trouble-free stock handling.

Environmental mastitis may decrease dramatically due to stock being less exposed to muddy, wet pasture conditions.

Aspects of the present invention have been described by way of example only and it should be appreciated that modifications and additions may be made thereto without departing from the scope thereof.

The above mentioned parts of the invention can allow for the temperature and/or airflow in the structure to be controlled to some extent in a manner that is passive and/or non electrical and/or non chemical.

What is claimed is:

1. An at least partially open sided outdoor animal shelter structure to condition animals, when positioned within the said structure, to a desired physiological state by controlling the environment in the structure, said structure comprising:
(a) a floor to support animals,
(b) side supports,
(c) a water impervious canopy supported by said side supports, said canopy being supported above at least part of said floor, said canopy allowing at least some ambient light to pass therethrough and into said structure,
(d) at least one of:
(i) a movable shade cloth, that in one position is located intermediate of the canopy and the animals when located in the structure and
(ii) an airflow control means to control airflow impinging the structure to control the direction of flow of air below said canopy.

2. A structure as claimed in claim 1 wherein said canopy is curved.

3. A structure as claimed in claim 1 wherein said airflow control means comprises a plurality of horizontally extending and parallel louver boards that (a) are proximate said canopy to define air inlets between said louver boards and (b) extends outwardly and downwardly along one or more sides of the structure, to direct airflow incoming to the area below the canopy in a direction parallel to the underside of the canopy.

4. A structure as claimed in claim 1 wherein said canopy comprises at least one closable vent.

5. A structure as claimed in claim 1 wherein the shade cloth can be positioned above at least part of the floor and below said canopy to, in at least one configuration shade at least part of the floor from ambient light entering the structure.

6. A structure as claimed in claim 1 wherein the shade cloth comprises two independently moveable parts with a gap able to be defined between adjacent edges of each part between the two parts, wherein when a gap is defined, air can escape from below the shade cloth parts to a zone above the shade cloth parts.

7. A structure as claimed in claim 6 where the shade cloth parts can be moved to be positioned to be lower at regions thereof proximate more the perimeter of the structure than inwardly of the perimeter to create a stack effect for rising air below said canopy.

8. A structure as claimed in claims 1 wherein the shade cloth can be moved between at least two of three configurations, a first configuration wherein the shade cloth extends from opposed sides of the structure upwardly towards the upper central region of the structure, a second configuration wherein the shade cloth extends horizontally, and a third configuration wherein the shade cloth presents at least one and preferably two concave face side down zones.

9. A structure as claimed in claim 1 wherein the structure is rectangular in plan shape and wherein the shade cloth consists of two parts, each part being substantially rectangular in shape and having its two major sides parallel to two major sides of the structure, wherein one of the major sides of each part is proximate more a respective side of the structure than the opposite major side, wherein the opposite major sides of both parts are proximate each other substantially midway between major sides of the structure, where the opposite major sides can move between (i) an upper position where for each part the opposite major side is higher than the other major side, and (ii) a lower position where for each part the opposite major side is at substantially the same height as the other major side.

10. A method of cooling air in an outdoor, at least partially open sided, animal shelter structure of a kind that comprises a floor for animals to stand on and above which is supported a light transmissive canopy and wherein a closable vent is provided in the canopy and wherein a movable shade cloth is provided that can extend above at least part of the floor and below the canopy, said method including the steps of:
(a) opening the vent, and
(b) positioning the shade cloth to shade at least part of the floor from ambient light entering through the canopy.

11. A method of heating air in an outdoor, at least partially open sided, animal shelter structure of a kind that comprises a floor for animals to stand on and above which is supported a light transmissive canopy and wherein a closable vent is provided in the canopy and wherein a movable shade cloth is provided that extends above at least part of the floor and below the canopy, said method comprising:
(a) closing the vent, and
(b) moving the shade cloth to expose more of the floor to ambient light entering through the canopy.

12. An outdoor animal shelter structure comprising
(a) a floor to support animals,
(b) a canopy, supported above said floor, for animals to stand under, said canopy able to provide at least partial shading from ambient sunlight and cover from precipitation for at least part of said floor, wherein the space between the floor and the canopy is along at least part of one side of the structure open to ambient atmospheric conditions, and
(c) air flow control means to control airflow in the space between the canopy and the floor, said airflow control means selected from at least one of:
i) at least one horizontally extending louver board located adjacent at least one edge of the canopy yet separated therefrom to define an air inlet to said structure, said louver boards movable to be oriented to direct part of any appropriately directed ambient airflow incident on the structure, through said inlet(s), and
ii) a closable opening through said canopy that, in its open condition, can allow airflow out of the space, through said canopy,
iii) a two part movable shade cloth that can (i) create a stack effect for rising air below said shade cloth parts and (ii) define a ceiling to restrict flow of air from below the shade cloth parts to above them.

13. A structure as claimed in claim 12 wherein the structure is four sided in plan shape and at least two of the sides are at least partially open to ambient atmospheric conditions and wherein a said louver board(s) is provided at or near each of said open sides.

14. A structure as claimed in claim 12 wherein the canopy is varied in height above said floor wherein the lower most parts of the canopy are disposed proximate said two opposed sides of said structure and at least one apex of the canopy is positioned intermediate thereof.

15. A structure as claimed in claim 12 wherein the canopy extends upwardly from each of said two opposed sides toward the apex.

16. A structure as claimed in claim 12 wherein the louver board projects away from said space in a downward direction in order to encourage said ambient airflow to enter said space in an upward direction.

17. A structure as claimed in claim 12 wherein said canopy is uni-directionally curved and defines an elongate apex extending intermediate of two opposed sides of said structure.

18. A structure as claimed in claim 12 wherein said closable opening is positioned along at least part of an apex of said canopy.

19. A structure as claimed in claim 12 wherein the closable opening is closable by a closure that is pivotally supported to move relative said canopy between a position closing said opening and a position to allow airflow through said opening.

20. A structure as claimed in claim 12 wherein the floor is supported above a basement and wherein the floor comprises a plurality of apertures to allow waste matter to drop through the floor and into the basement.

21. A structure as claimed in claim 20 wherein the floor is elevated above at least some ground adjacent to where the structure is positioned to define an opening via which part of any appropriately directed ambient airflow incident on the structure to pass into the basement.

22. A structure as claimed in claim 20 wherein at least one side of the structure the basement comprises an opening directly exposed to ambient atmospheric conditions to allow part of any appropriately directed ambient airflow to enter the basement.

23. A structure as claimed in claim 20 wherein an airflow control means is provided to alter airflow through said opening to said basement.

24. A structure as claimed in claim 23 wherein said airflow control means is a movable baffle.

25. A structure as claimed in claim 24 wherein said baffle can be positioned to scoop airflow towards said opening.

26. A structure as claimed in claim 24 wherein said baffle can be positioned to constrict airflow through said opening

27. A method of a conditioning a dairy animal prior to it being milked, to encourage its condition towards a homeostatic physiological state to improve milk yield (whether milk quality or quantity or both), the method including moving or allowing movement of the dairy animal into a shelter structure as claimed in claim 1 or 12 that is configured to create an environment for the dairy animal to remain in for a duration prior to milking, that will tend the condition of the dairy animal towards the desired homeostatic physiological state.

28. A method as claimed in claim 27 that comprises keeping the dairy animal in the shelter structure for at least 10 minutes before advancing or allowing movement of the dairy animal from the shelter structure to a location for their milking

29. A method as claimed in claim 27 wherein the shelter structure comprises environment sensors that allow at least one environment measurement to be taken and used for recordal and/or processing and/or feedback control for structure configuration.

30. A method of conditioning cows prior to their being milked to encourage them to or towards an optimal homeostatic physiological condition for milk productivity and/or milk quality, the method including moving or allowing movement of cows from a location where they are subjected to environmental conditions that can have an adverse effect on the physiological condition of the cows, into a shelter structure as claimed in claim 1 or 12, the structure configured to create an environment for the cows to remain in for a duration prior to milking that will tend the cows towards the optimal homeostatic physiological condition.

31. An outdoor animal shelter structure comprising
(a) a floor to support animals,
(b) a canopy, supported above said floor, for animals to stand under, said canopy able to provide at least partial shading from ambient sunlight and cover from precipitation to at least part of said floor,
(c) two drooping shade cloth parts each positioned intermediate of said canopy and said floor and under which said animals can stand to provide at least a partial barrier to the passing of sunlight to below said shade cloth and to facilitate the flow of air below said shade cloths in an inward and upward direction in the structure.

32. A structure as claimed in claim 1 wherein the shade cloth can be moved to a condition to encourage updraft of air in said structure.

33. A structure as claimed in claim 32 wherein said shade cloth can be moved to a condition where at least one part of it is/are elevated more than other parts and wherein at the elevated most part(s) comprises an aperture to allow rising air to pass therethrough.

34. A structure as claimed in claim 32 wherein said canopy comprises a closeable opening to allow rising air to pass therethrough.

35. The structure of claim 1, wherein said floor comprises apertures therethrough allowing animal waste matter to pass through to the floor.

36. The structure of claim 35, further comprising a basement below said floor for collecting said waste matter.

37. The structure of claim 36, further comprising floor supports to support said floor above said basement.

38. The structure of claim 4, wherein the vent is at an apex of the canopy.

39. The structure of claim 5, wherein said ambient light is sunlight.

40. The structure of claim 9, wherein a gap exists between parts of said upper position to allow rising air to escape to the zone between the shade cloth and the canopy and/or out through the canopy vent.

41. The structure of claim 9, wherein no gap exists between the parts of the lower position or any gap is closed.

42. The structure of claim 10, wherein the shade cloth is positioned in a manner to allow air entering the structure through the sides of the structure to either circulate below the shade cloth or, if the shade cloth consists of two parts and is positioned with a gap between parts, to pass into said structure below the shade cloth parts, pass through the gap and into the space between the canopy and the shade cloth and/or out through any vent in the canopy.

43. The structure of claim 12, wherein the two part movable shade cloth can assume a curved condition so as to present a concave ceiling that will encourage air to circulate below said shade cloth.

44. The structure of claim 12, comprising a plurality of said louver boards parallel to each other.
